(19) United States
(12) Patent Application Publication
(10) Pub. No.: US 2010/0115613 A1
(43) Pub. Date: May 6, 2010

(54) Cacheable Mesh Browsers

(75) Inventors: Prem Ramaswami, Branchburg, NJ (US); Satishkumar Sampath, Bangalore (IN)

Correspondence Address: STERNE, KESSLER, GOLDSTEIN & FOX, P.L.L.C., 1100 NEW YORK AVENUE, N.W., WASHINGTON, DC, 20005, US

(73) Assignee: Google Inc., Mountain View, CA (US)

(21) Appl. No.: 12/262,903

(22) Filed: Oct. 31, 2008

(51) Int. Cl. G06F 12/14; G06F 7/06; G06F 17/30

(52) U.S. Cl. 726/22; 707/E17.108; 707/E17.111

(57) ABSTRACT

Methods and systems for improving the end-user experience by reducing the latency of data access across networks by accessing peer browser caches are disclosed. In one embodiment, a method of accessing a web data element includes: transmitting a first request for the web data element from a first browser to a home location of the web data element; transmitting a second request for the web data element from the first browser to one or more hosts including a second browser accessible by the first browser; receiving a cached copy of the web data element by the first browser from the second browser; and displaying the cached copy of the web data element. In another embodiment, a method of improving access to a web data element, includes: receiving a copy of the web data element at a first browser in response to a first request initiated from the first browser; storing the copy of the web data element in a cache controlled by the first browser as a cached web data element; receiving a request for the web data element from a second browser; and providing a copy of the cached web data element to the second browser.

### BACKGROUND

1. Field

Embodiments of this invention relate generally to reducing the latency of accessing data elements across one or more networks.

2. Background Art

Content access and content delivery through networks such as the Internet has become pervasive. For example, the World Wide Web (WWW or Web) is a system of interlinked documents accessed via the Internet. The Internet is a loose interconnection of numerous networks that allows a host connected to one network to access data on a server located in a second network possibly in another part of the world. Based on hypertext documents, the Web allows various types of files, such as audio, video, images, text, and other types of binary files to be displayed, accessed, stored and retrieved.

As the Web becomes increasingly rich in content, and as the sophistication of the content (e.g., higher quality images and video) increases, the number of people accessing the web as well as the frequency of web access keeps increasing. Often, a user accesses content in a data center that is located many network hops away from the user. Accessing content on distant network locations increases overall network traffic as well as latency to obtain the requested content. The increased traffic may cause network congestion and lead to poor overall performance in access to content using the Web. While the networks are frequently upgraded to higher capacities, the amount of traffic flowing through the networks is also constantly increasing.

Content available on the Web is in the form of a webpage and/or data elements being linked to from a webpage. A webpage is typically in Hyper Text Markup Language (HTML) or a variant thereof, and may contain links to one or more other webpages or other content such as images, audio files, video files, executable content, and scripts. A webpage can include text, images, HTML language elements, and links to other content. Each element, such as a webpage or linked content is, in general, separately downloaded from its original location (home location). The home location is the server identified by the URL corresponding to that element. All elements of a particular webpage are not required to have the same home location. The requesting browser is generally referred to as a client browser.

Many techniques have been used to enhance the end-user experience in accessing content over networks. For example, content may be compressed on the server and be decompressed only when it is received at the client browser. Client side programs may perform processing activities on the client, reducing the frequency of access to servers for a particular task. Server content may be transparently duplicated at multiple locations so that clients have a shorter distance in network hops to reach desired content. Proxy caches may cache server content so that local clients have faster access to selected content. Web browsers (browsers) may cache content locally so that the browsers may simply serve up some content from the local cache when that content is needed again. Some peer-to-peer networking approaches are also conventionally used to speedup the delivery of content to requesting clients. Each of these techniques serve to reduce network traffic and reduce congestion while enhancing the end-user experience. Often a combination of several approaches, including one or more of the approaches noted above, is employed to enhance the end-user experience and improve network utilization. But, the need for new techniques to improve the end-user experience and network utilization remains.

Services that transparently replicate server content to multiple servers improve the end-user experience and network utilization by moving content closer to requesting clients. The process of replicating server content is generally transparent to browsers, and the browsers are directed to the replicating servers transparently. For example, a corporate web server may replicate its content to multiple replicating servers distributed throughout the Internet. Browsers accessing the corporate web server using its predetermined uniform resource locator (URL), can be transparently directed to a suitable replicating server by appropriately resolving and responding to domain name service (DNS) queries of the browser to return the address for that replicating server. Networks of replicating servers are sometimes referred to as content delivery networks (CDN).

Proxy caches are generally intermediate network nodes that intercept requests for web content (web requests) from browsers. In general, a proxy cache re-issues an intercepted web request to the web server such that the proxy cache will receive the response. The responses thus received are cached in the proxy cache and are used to service subsequent requests for the same content by any browser whose requests are intercepted at the proxy. Proxy caches are primarily implemented in a manner that the proxy cache intercepts web requests from browsers in a local network such as a corporate local network or the local network of a school. The cache maintained by the proxy cache can benefit all browsing clients in the local network.

Most current web browsers implement a local cache. When content is obtained from a web server, the browser stores a copy of that content in its own local cache. Subsequent requests for the same content can be serviced by simply retrieving that content from the local cache. The local cache allows each browser to first seek to retrieve content from its own cache, before sending out any messages on to the network.

Delivery mechanisms based on peer-to-peer network technology are used for distributing content such as audio and video files. For example, BitTorrent is a technology that allows a client wanting to download a file to connect to multiple sources having that file or portions thereof to complete the download speedily. BitTorrent also turns clients that downloaded any files into servers from which others can download all or parts of such downloaded files. A client uses BitTorrent to download content by first discovering its peer group of other BitTorrent clients. In general, the group of peers from which a client can download a file is determined by a specialized node identified as the ‘tracker’ for the specified content. A client identifies a tracker by locating a ‘torrent’ file that lists the desired content. The torrent file is created by each node that becomes a part of the BitTorrent delivery network, and lists the files (or the parts of the files) that are available from that node. A client wanting to download a particular content first locates a torrent, and based on the torrent connects to the specified tracker. In turn, the tracker provides the information necessary for the BitTorrent client initiating the download to download the content. Some BitTorrent implementations may not have centralized trackers, and would distribute the tracker functions among all BitTorrent peers. These implementations still require the corresponding torrent to be obtained prior to retrieving content.

The conventional approaches, including those described above, help improve the end-user experience and network utilization. However, as the Web and Internet continues to grow adding users, networks, and content of increasing complexity, there remains a need for methods and systems for further improving the end-user experience and network utilization.

### SUMMARY

Methods and systems for improving the end-user experience by reducing the latency of data access across networks are disclosed. In one embodiment, a method of accessing a web data element includes the stages of: transmitting a first request for the web data element from a first browser to a home location of the web data element; transmitting a second request for the web data element from the first browser to one or more hosts including a second browser accessible by the first browser; receiving a cached copy of the web data element by the first browser from the second browser, where the cached copy of the web data element was stored in a cache associated with the second browser; and displaying the cached copy of the web data element using the first browser, where the cached copy of the web data element is received by the first browser before the first browser receives the web data element from the home location.

In another embodiment, a method of improving access to a web data element, includes the stages of: receiving a copy of the web data element at a first browser in response to a first request initiated from the first browser; storing the copy of the web data element in a cache controlled by the first browser, where the copy of the web data element is stored as a cached web data element; receiving a request for the web data element from a second browser, where the request for the web data element is sent in conjunction with a request from the second browser to a home location of the web data element; and providing a copy of the cached web data element to the second browser.

In another embodiment, a system for using a browser cache for accessing a web data element, includes a first browser and a second browser coupled to a network. The first browser has a caching module configured to receive a copy of the web data element and to store the copy of the web data element in a cache, and a peer cache response module configured to receive a third request from the second browser for the web data element, and to provide a copy of the cached web data element to the second browser. The second browser includes a peer cache request module configured to transmit a second request for the web data element to a home location of the web data element, to transmit the third request to an address accessible by the first browser, and to display the copy of the cached web data element.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a network according to an embodiment of the present invention.

FIG. 2 shows a computer according to an embodiment of the present invention.

FIG. 3 is a flowchart showing processing stages in two browsers according to an embodiment of the present invention.

FIG. 4 shows a request for web content and a response with web content, according to an embodiment of the present invention.

FIG. 5 shows a scheme that can be used for locating cached web data elements according to an embodiment of the present invention.

### DETAILED DESCRIPTION OF EMBODIMENTS

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

### Overview

The Web continues to grow adding users, networks and content. Although the networks that comprise the Web and the Internet constantly increase in bandwidth, the growth of the number of users and amount and complexity of content continues the need for new technologies to improve the end-user experience and the corresponding network utilization.

The invention disclosed herein, in one embodiment, includes methods and systems to leverage the caches of one or more browsers in a local network for the benefit of all browsers in that local network. The methods and systems disclosed herein can be used by themselves or in combination with one or more conventional approaches (e.g., compression, client-side scripts, content delivery networks, proxy caching, local browser caching, peer-to-peer file delivery, etc.) to improve the end-user experience and network utilization. The methods and systems disclosed herein are expected to yield better end-user experience and network utilization while causing an increase in message exchanges only within a local network.

An example use of an embodiment of the present invention may be illustrated considering users accessing the Web using browsers located on a local area network (peer browsers) in an environment such as an internet cafe. In general, the local area network within the internet cafe constitutes very high bandwidth links compared to the link outgoing to the Internet from the internet cafe. In certain instances, such as when a breaking news story occurs, when many of the users in the internet cafe are participating in an educational exercise, or when a web portal contains content of interest to a wide section of local population, the same content may be accessed by more than one user. A user (or more accurately, the corresponding browser) who receives the content that he requested may cache that content. Subsequently, a second user who desires that same content can, simultaneously while requesting the content from the known location for that content (herein the home location), request that content from other users on the same local area network. One or more sources may respond to the request from the second user. The second user may use the content from the first received response, which may either be from the home location or another browser from the same network. By enabling each browser in the peer group of browsers to share its cache with other browsers in the same peer group, the embodiments of the present invention form a logical mesh of caches in a local network. This process will be further described below.

In the above example, it can be seen that embodiments of the present invention can be used seamlessly with many of the other technologies mentioned above to improve the end-user experience. For example, the approach taught in this disclosure is complementary to content distribution networks, proxy caching, and local caching. Any increase in message traffic generated is restricted to the corresponding local area network. The improvement in the end-user experience may correspond to the reduction of the latency in obtaining content. Therefore, as the external networks and/or servers experience increasing congestion, the relative advantages of embodiments of the present invention increase. Also, as the volume of content that is obtained from caches of peer browsers increase, the relative advantages of embodiments of the present invention increase. For example, if a large number of users on the same local network desire to view a video file of substantial length, having the video file accessible in a peer cache is likely to significantly reduce the access times involved for most users.

Embodiments of the present invention, in effect, distribute a cache among browsers in a predetermined area. The distribution of the cache can enable a user to have access to a larger cache, having cached content that is more consistent because each cache is maintained by the corresponding browser, and not having a single point of failure such as a proxy cache. The present invention, in one embodiment, dispatches requests to obtain content to the home location of a particular content element as well as to the local network, thereby benefiting from content cached by a local peer while not getting penalized with increased latency if the content is not found in the cache of a peer browser.

### System Components

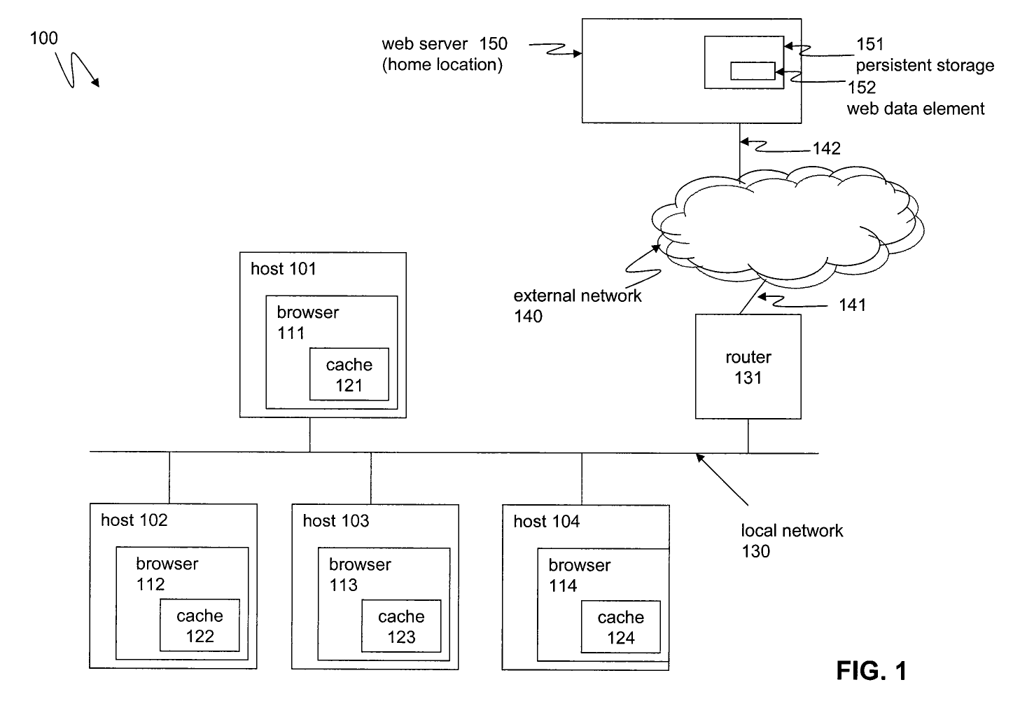

FIG. 1 illustrates an environment 100 in which peer browser cache sharing is performed in accordance with an embodiment of this invention. Hosts 101, 102, 103 and 104 include internal browsers 111, 112, 113 and 114, respectively. Hosts 101, 102, 103 and 104 all connect to the same local network 130. For illustrative purposes, each host includes one active browser, for example, browser 111 is active on host 101, browser 112 is active on host 102, browser 113 is active on host 103, and browser 114 is active on host 104. Hosts 101, 102, 103 and 104 also include internal browser caches 121, 122, 123 and 124, respectively. Each browser cache is controlled by the respective browser, for example, browser cache 121 is controlled by browser 111, browser cache 122 is controlled by browser 112, browser cache 123 is controlled by browser 113, and browser cache 124 is controlled by browser 114. Hosts 101, 102, 103, and 104 may each be any computing device on which a browser can be used, such as, for example, a personal computer, personal digital assistant (PDA), or an embedded device. Browsers 111, 112, 113, and 114 may be any web browser. Some embodiments of the present invention may require that browsers 111, 112, 113, and 114 are of the same type. Other embodiments, however, may only require that certain aspects of caching and communication are supported by each browser 111, 112, 113, and 114 so as to permit interaction among peer browsers. Each browser cache may include space in the corresponding host's dynamic memory as well as in that host's persistent memory.

Local network 130, in general, may include one or more interconnected networks under one administrative domain. An administrative domain is a collection of hosts, routers, and the interconnecting networks managed by a single administrative authority. In the embodiment shown in FIG. 1, local network 130 is a local area network (LAN) that is connected to external network 140 through router 131. LAN 130, for example, may be a wired network such as ethernet, gigabit ethernet, a wireless network such as IEEE 802.11, or a combination thereof. Router 131 is connected to LAN 130 with one interface, and to external network 140 with interface 141.

A web server 150 having one or more web data elements is connected to external network 140 through a connection 142. Web server 150 can be any computer executing an instance of web server software such as, for example, the Apache web server software produced by the Apache Software Foundation. In this disclosure the term web server is used collectively for the computer and the executing instance of the web server software. Web server 150 may also include of one or more computers that are load sharing and/or replicating the relevant web data content. Web server 150 can include a persistent memory (not shown) such as a hard disk drive and/or a dynamic memory (not shown). Web data elements including web data element 152 may reside in persistent memory or in dynamic memory on web server 150. Web data element 152 may be one of several types of data elements, such as an HTML-based web page, an image, an audio file, a video file, a script, executable code, or other binary code. Web server 150 may make web data element 152 accessible to browsers including browsers 111, 112, 113 and 114.

External network 140 may include one or more networks including the Internet. Router 131 can be any device that can exchange packets between LAN 130 and external network 140. For example, in the embodiment shown in FIG. 1, router 131 may perform routing of Internet Protocol (IP) packets from LAN 130 to web server 150 that is connected via external network 140, and vice versa. In a typical network spread across geographic areas, particularly when the end-to-end connectivity involves traversing a large network such as the Internet, a packet may encounter multiple routers in its path to the destination. The number of routers encountered on a path traversed by a packet is generally referred to as the “hop count” of that path, and is a measure of the distance and/or cost related with that path.

In addition to the hop count, another measure of the cost of a connection or link may be the bandwidth and latency associated with the corresponding link. In the embodiment shown in FIG. 1, interface 141, that connects LAN 130 and its hosts to external network 140, may be relatively slow compared to LAN 130. For example, LAN 130 may be a gigabit ethernet network having a bandwidth of 1 Gbps while link 141 may be a dial-up internet link at 128 kbps. In such a situation, any web request from a host on LAN 130 to web server 150, is likely to experience latency due to interface 141.

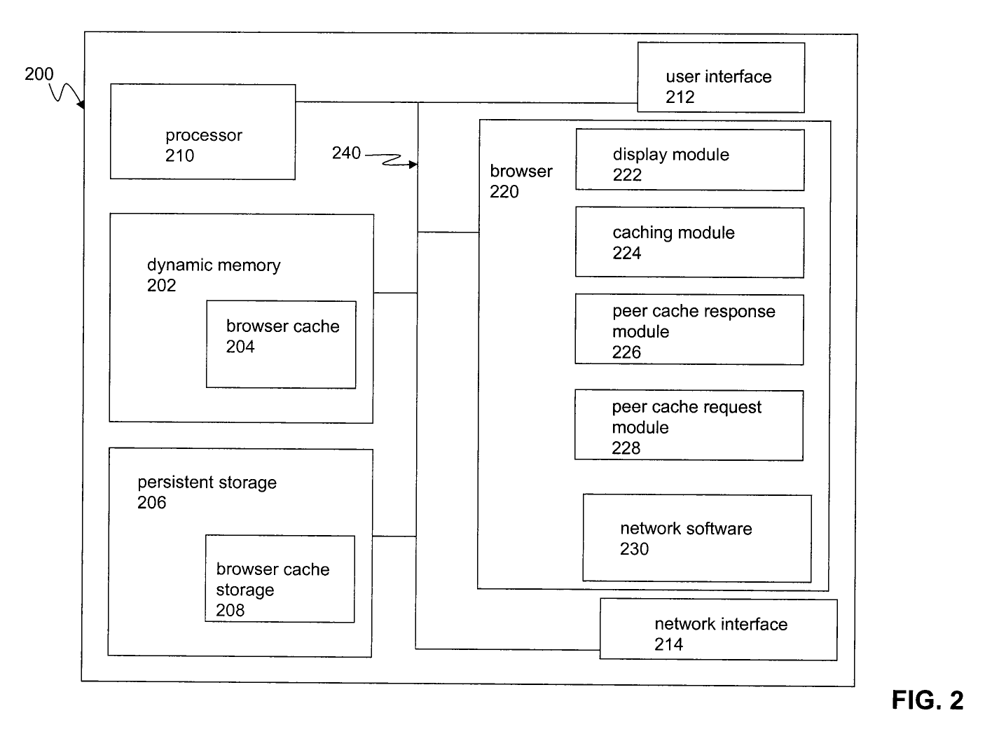

FIG. 2 shows components of a host 200 (e.g., such as host 101, 102, 103 or 104) according to an embodiment of the present invention. Host 200 includes a processor 210, a dynamic memory 202, a persistent memory 206, a user interface 212, and network interface 214, interconnected by a system bus 240. Host 200 also includes a browser software module 220. Dynamic memory 202 includes a browser cache 204. Persistent memory 206 includes an area for browser cache storage 208. Browser module 220 can include a display module 222, a caching module 224, a peer cache response module 226, a peer cache request module 228, and a network software module 230.

Processor 210, dynamic memory 202, persistent memory 206, user interface 212, and network interface 214, can be of types usually found on a general purpose personal computer, personal digital assistant, and/or smartphone. Processor 210 may include a general purpose microprocessor or a specialized processor. Dynamic memory 202, for example, may include of one or more variants of random access memory (RAM). Persistent memory 206 may include a hard disk, optical disk, flash memory, or similar storage medium. User interface 212 may include a keyboard device, a mouse or tracking device, and a display. Network interface 214 may be an interface capable of transmitting and receiving data packets form one or more networks compliant with standard protocols, such as, ethernet, gigabit ethernet, IEEE 802.11, or a non-standard communication protocol. System bus 240 may be a communication device compliant with a standard such as Peripheral Component Interconnect (PCI).

Browser 220 is defined using any one or more computer programming language or scripting language, such as Java, C, C++, or Perl. Processor 210 creates an instance of browser 220 that executes exchanging data with dynamic memory 202, persistent memory 206, user interface 212, and network interface 214, over system bus 240.

According to the teachings in this disclosure, browser 220 controls browser cache 204. In some embodiments, maintaining browser cache 204 may include storing all or part of the data in browser cache 204 in browser cache storage 208. For example, for reasons including reliability and scalability, some or all of the data in browser cache 204 may be automatically stored in browser cache storage. However, in general, the process of transferring data between browser cache 204 and browser cache storage 208 is transparent to browser 200. In the rest of this disclosure, browser cache refers to the combined browser cache 204 and browser cache storage 208 unless specifically noted.

Caching module 224 is a component of browser 220 that stores and retrieves data from the browser cache (e.g., browser cache 204). For example, browser 220 may use caching module 224 to seek a web data element from its local browser cache for its own use, or in order to respond to a request from a peer browser. Caching module 224 may also include functionality to insert received web data elements into the browser cache.

Peer cache response module 226 includes the functionality for a peer browser with an active browser cache to receive a peer request for a web data element, locate the desired web data element in its browser cache, and to send back a copy of the desired web data element to the requesting peer browser.

Peer cache request module 228 includes functionality to generate web data element requests to be sent to peer browsers. For example, browser 220 may use peer cache request module 228 to identify web data elements that should be requested from the peer browsers (in addition to requesting from the home location for that web data element) and creating and sending the request message to be sent to the peer browsers.

Network software module 230 may include functionality to packetize, address, and send web data element request messages to network interface 214 to be transmitted on to a network. Network software module 230 may also include functionality to receive packets addressed to a peer browser group and to make those messages available to peer cache request module 228. A person skilled in the art will understand that network software module 230 encompasses much of the functionality of conventional IP network software with some modification and/or configuration to recognize packets from peer browsers.

### Message Exchange and Cache Processing

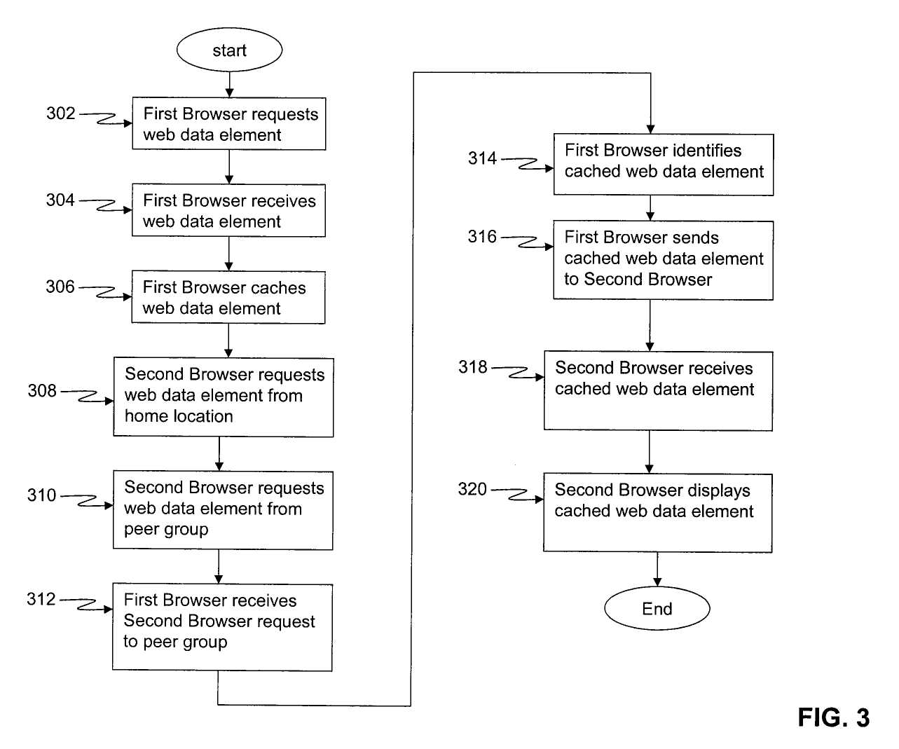

FIG. 3 is a flowchart illustrating the exchange of messages among peer browsers and cache interactions according to an embodiment of the present invention. For ease of description, only the exchanges between two browsers and a server are illustrated in FIG. 3. A person skilled in the art will understand that the disclosed method scales with a larger number of peer browsers and a larger number of servers.

In stage 302, a first browser (e.g., browser 112 on host 102) requests a web data element. For example, browser 112 may request web data element 152 from web server 150. The communication between browser 112 and web server 150 may be based on protocols including the Hypertext Transfer Protocol (HTTP). Therefore, the request for web data element 152 may be generated as a HTTP GET massage from browser 112 to web server 150.

The web data element being requested from a web server may be an HTML page or a linked element such as an image, audio or video file. In general, the web data element to be retrieved is specified, by a user or in the form of a linked element in a webpage, as a uniform resource locator (URL) that includes the domain name of the server (e.g., http://www.google.com). Before the packet or packets containing the web data element request leaves the requesting host, an appropriate IP address is determined that corresponds to the web server identified by the URL. The resolution of a URL and/or domain name to an IP address may be handled by components of the requesting host including its network software module (e.g., network software module 214 of host 200). The specific details of resolving a URL and/or domain name based identifier to an IP address, generating one or more IP packets from a message to be sent, addressing the packets, transmitting the packets onto the network, receiving packets, extracting messages out of received packets, etc., are not described here because the details of such aspects are not directly relevant to this invention, and are generally known to persons of skill in the art.

In stage 304, the browser requesting the web data element in stage 302 receives a response from the corresponding web server containing a copy of the requested web data element. For example, browser 112 may receive an HTTP OK response message from web server 150. The response contains a copy of web data element 152 and may also include, for example, information such as the server that returned the associated data (in this example, the copy of web data element 152), the length of the associated data in bytes, the type of content of the associated data (e.g., audio file format, image file format, etc.), whether the copy of the associated data is compressed or encrypted, an expiry time that may indicate to caches to not cache the associated data beyond the indicated time, and information as to when the associated data was last modified.

In stage 306, the browser that received the copy of the web data element from the web server saves a copy of the web data element in its cache. For example, browser 112 may invoke the services of a caching module (e.g., caching module 224) to store a copy of web data element 152 in cache 122. In some embodiments, the decision whether to cache the web data element may consider such aspects as the location from where the web data element was received, the type and size of the web data element, and the time of expiry of the web data element. For example, if web server 150 has marked, in its response, that the copy of web data element 152 has an expiry time that is already passed, caching module 224 would not store a copy of web data element 152 in its cache.

In stage 308, a second browser (e.g., browser 111 on host 101) in the same local network as the first browser requests the same web data element requested by the first browser in stage 302. The request in stage 308, similarly to the request made in stage 302, is addressed to the web server. For example, browser 111 may request, using an HTTP GET message, web data element 152 from web server 150. Web server 150 may be considered the home location of web data element 152, if as in this example, the URL for web data element 152 resolves to identify web server 150. Prior to generating the HTTP GET message, browser 111 may seek to find a copy of the web data element 152 in its own cache 121. The HTTP GET message would be transmitted by browser 111 if the sought data is not found it its cache 121 or if it was found in cache 121 but indicated that it was expired.

Immediately after transmitting the HTTP GET request to the web server in stage 308, in stage 310, the second browser transmits a corresponding GET message to an address accessible by one or more other browsers on its local network. It is expected that the request of stage 310 will be transmitted before the second browser receives a response for its request transmitted in stage 308.

For example, in stage 310, browser 111 may use its peer cache request module (peer cache request module 228) to create and transmit a request for a cached copy of web data element 152 to its peer browsers on the LAN 130. The set of peer browsers include browsers intended to be peer browsers by sharing their respective caches with other browsers on the same network. Sending a request message to peer browsers (in the form of IP packets) may include broadcasting the message on the local networks, multicasting to an address listened to by peer browsers, or unicasting to a single predetermined peer browser. For example, upon startup, every browser intending to be a peer browser may register a predetermined IP multicast address for peer browsers. Subsequently any requests for peer browsers may be addressed to and received at that predetermined multicast IP address for peer browsers. Addressing IP packets to a multicast address, in general, can restrict those packets to a predefined local network, and is an efficient means to communicate simultaneously with browsers in a peer group. Transmitting the request packets to a broadcast or unicast address may be less efficient than transmitting the same to a multicast address. Broadcasting, multicasting, and unicasting in networks, including IP networks, is well known and is not described in detail in this disclosure.

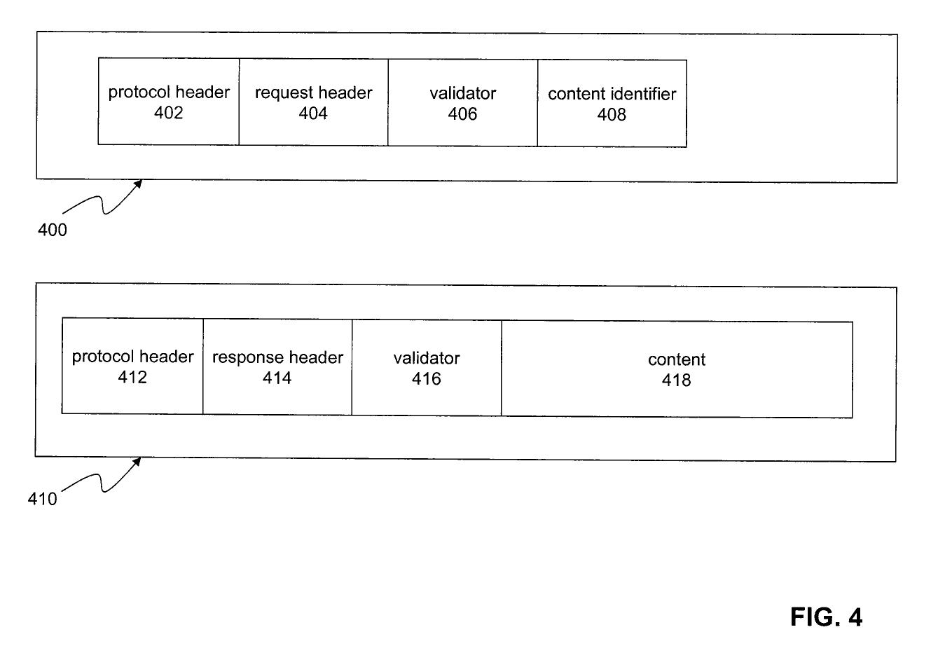

The request to peer browsers may be of a form similar to message 400 of FIG. 4. Message 400, for example, includes: a protocol header part 402 that may include network, transport, and/or application layer header information such as IP, UDP (User Datagram Protocol) or TCP (Transport Control Protocol), and HTTP header information; a request header part 404 that may include a command such as HTTP GET or a variant thereof; a validator part 406 that may include information such as a checksum (for example, a referring web page may have indicated a checksum for this web data element) to ensure the validity of the data being sought and expiry information; and identifying information for the sought content 408 (also referred to herein as content identifier 408) such as the corresponding file name or URL. It will be understood by persons of skill in the art, that some embodiments of the present invention may have a validator integrated to the identifier, and some may have no validator.

In stage 312, the first browser receives the request for a cached copy of the desired web data element sent by the second browser to its peer browsers, and in stage 314 the first browser locates the desired web data element in its cache. For example, browser 112 receives the request sent by browser 111 in stage 310. In some embodiments of the present invention, browser 112 or the components of browser 112 necessary to receive and process requests sent by browser 111 may be active regardless of whether a user is actively using browser 112. Software in browser 112 (e.g., peer cache response module 226) can determine if cache 122 has the requested content (e.g., a copy of web data element 152).

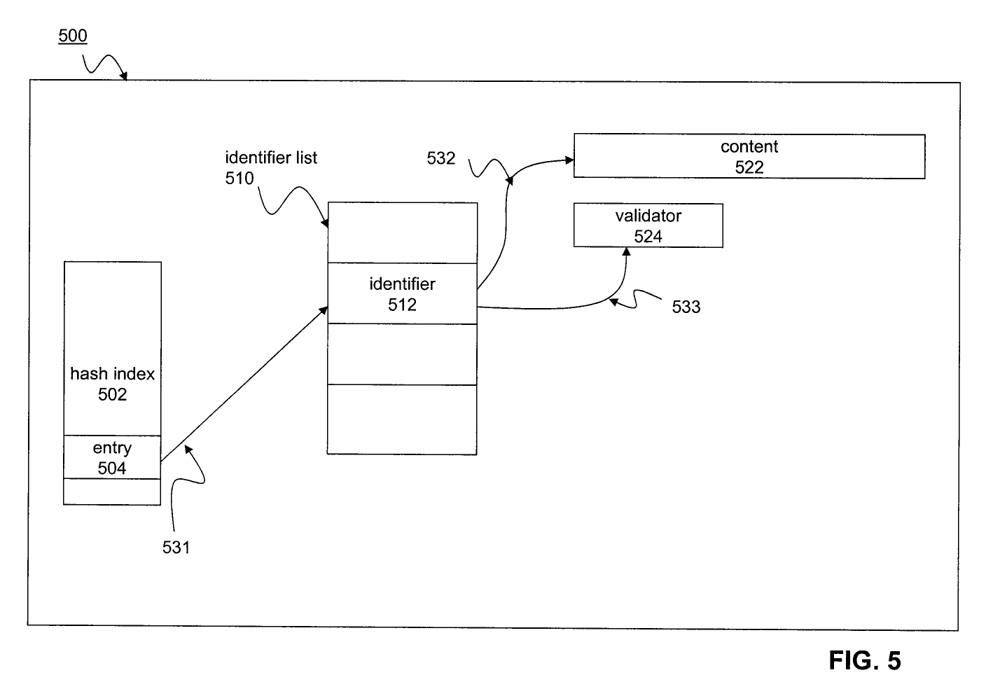

An example cache organization 500 that may be used in cache 122 is shown in FIG. 5. Cache organization 500, in one embodiment of the present invention, is based on a hashed index 502 that allows the efficient location of a matching identifier of cached content. The identifier may be based on a unique identifier for the particular content, such as, for example, the URL or another identifier designed to be sufficiently distinguishable over the set of potential identifiers. For example, having received message 400 from browser 111, browser 112 may attempt to determine if content identifier 408 is present in its cache 122. Browser 112, through its peer cache response module and/or caching module (e.g., modules 226 and 224, respectively) locates a matching hash entry 504 in hash index 502 that points 531 to identifier 512 in a list of identifiers 510 that matches the required content identifier 408. With each identifier, cache 122 may have stored the corresponding content 522 in a location pointed to by a pointer 532, and the corresponding validator 524 in a location pointed to by a pointer 533. In determining if the located cache entry is valid, browser 112 may compare validator 406 received in request message 400 from browser 111 with validator 524 associated with the matched identifier 512. Matching validators may involve matching checksums designed to uniquely identify content as well as to ensure the retrieval of a true unaltered version of the desired web data element. Matching validators may also involve the comparison of expiry information to determine if the cached data is to be considered valid. If the validators correspond, then content 522 is considered available for returning to the requesting browser 111.

The peer cache response module of browser 112 may create a response to be sent to browser 111 with a copy of the matching content 522. For example, the response message sent to browser 111 from browser 112 may be of the form of response message 410. Protocol header 412, response header 414, and validator 416 correspond in function to fields 402, 404, and 406, respectively, of request message 400. Response header 414 may indicate that message 410 is a HTTP OK message or a variant thereof. Validator 416 may include validator 524 from cache 122. Content 418 includes the content being returned to browser 111, in this example, content 522 found in cache 122. Message 410 may be sent directly addressed to browser 111 (e.g., address of host 101 on LAN 130).

In stage 316, the first browser responds to the second browser with the content from the cache of the first browser, as described above. In stage 318, the second browser receives a response from a peer browser containing the web data element that was requested. Following the example above, in stage 318, browser 111 receives message 410 from browser 112 containing a copy of web data element 512. Receiving message 410 at browser 111 may include re-validating the received content and eliminating duplicates sent by multiple peer browsers.

If, at or before receiving message 410 from a peer browser, browser 111 receives a response with the desired content from the home location of the web data element 152 or other server that is not a peer browser, those response messages from the peer browsers containing information from their respective caches will be discarded in favor of accepting the response returned with non-cached information. In another embodiment, browser 111 may consider additional factors such as the total size of the content to be received compared to the size of the content already received (if any), and/or validity information associated with the content before deciding whether to use cached information or non-cached information. However, embodiments of the present invention are most beneficial where there is a significant difference in the delay between retrieving information from a cache in the local network as opposed to retrieving that information from its home location across a larger network.

In stage 320, the cached content received in stage 318 is displayed in the second browser. For example, the content included in message 410 is displayed in browser 111. The process of displaying may include an action appropriate for the type of content in web data element 152. For example, if web data element 152 includes a script or executable code, then displaying in stage 320 may include executing the script of executable code, and if web data element 152 an audio file, display may include enabling the audio to be played.

Stages 302, 304, 306, 308, 310, 312, 314, 316, 318 and 320 illustrate message exchanges and cache activity involved in one embodiment of the present invention. Modifications including different combinations of the above stages are possible while being consistent with the present invention. For example, in another embodiment, stages 310 and 308 may be swapped to first transmit the request message to the peer group. In another embodiment, the local network in which the peer browsers reside may spread beyond a local area network (for example, a peer browser may belong to a multicast group that spreads wider than a local area network or single administrative domain). Embodiments that involve peers other than web browsers can also be envisioned.

In yet another embodiment, a first browser being requested for cached data by a peer, may proactively send additional cached web data elements that are linked to the requested data element. Often it is likely that the first browser has multiple such related web data elements in its cache. Such a proactive cache response can significantly reduce both the latency in accessing web pages or other documents and network traffic.

A notable strength of embodiments of the present invention is that they can co-exist with conventional methods of end-user experience improvement (such as those described earlier in this disclosure) and can scale well as the peer group increases in number.

Appropriate considerations must be accorded to issues of privacy and copyright concerns particularly when implementing the teachings in this disclosure using a peer browser group spreading beyond a single administrative domain. For example, requests to peer browsers and responses from peer browsers may be encrypted in a manner so as to enable the peer browsers to protect the privacy of corresponding users.

### Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of accessing a web data element, comprising:
(a) transmitting a first request for the web data element from a first browser to a home location of the web data element;
(b) transmitting a second request for the web data element from the first browser to a second browser accessible by the first browser;
(c) receiving a cached copy of the web data element by the first browser from the second browser, wherein the cached copy of the web data element was stored in a cache associated with the second browser; and
(d) displaying the cached copy of the web data element using the first browser,
wherein the cached copy of the web data element is received by the first browser before the first browser receives the web data element from the home location.

2. The method of claim 1, wherein the first browser and the second browser are both accessible on a first network.

3. The method of claim 2, wherein the first network is contained in one administrative domain.

4. The method of claim 2, wherein the first network is a local area network.

5. The method of claim 2, wherein the home location is on a second network, and wherein packets from the first network to the second network traverse one or more routers.

6. The method of claim 2, wherein the home location is on a second network, and wherein the first network and the second network are in different administrative domains.

7. The method of claim 1, wherein the web data element includes one or more of, a webpage, or a linked data element.

8. The method of claim 7, wherein the linked data element includes one or more of a webpage, a graphic file, an audio file, a video file, a document, a binary file, a script, or an executable code component.

9. The method of claim 7, wherein the linked data element includes static web content.

10. The method of claim 1, wherein the second browser comprises a web browser.

11. The method of claim 1, wherein stage (b) comprises:
determining an address, wherein the address is assigned to a peer browser group;
addressing the second request to the peer browser group; and
sending the second request.

12. The method of claim 1, wherein stage (d) comprises:
verifying the copy of the cached web data element at the second browser; and
implementing the copy of the cached web data element in the second browser.

13. The method of claim 12, wherein verifying the copy of the cached web data element includes:
comparing a first authenticator and a second authenticator, wherein the first authenticator is included with the copy of the cached web data element, and wherein the second authenticator is known to the second browser.

14. A method of improving access to a web data element, comprising:
(a) receiving a copy of the web data element at a first browser in response to a first request initiated from the first browser;
(b) storing the copy of the web data element in a cache controlled by the first browser, wherein the copy of the web data element is stored as a cached web data element;
(c) receiving a request for the web data element from a second browser, wherein the request for the web data element is sent in conjunction with a request from the second browser to a home location of the web data element; and
(d) providing a copy of the cached web data element to the second browser.

15. The method of claim 14, wherein stage (d) comprises:
identifying the cached web data element in the cache; and
transmitting the copy of the cached web data element to the second browser.

16. The method of claim 15, wherein identifying the cached web data element comprises:
comparing a first authenticator with a second authenticator corresponding to the cached web data element, wherein the first authenticator is included in the request for the web data element.

17. The method of claim 15, wherein transmitting the copy of the cached web data element comprises:
creating a response message including the copy of the cached web data element; and
generating one or more packets that include the response message, wherein the packets are addressed to an address accessible to the second browser.

18. A system for using a browser cache for accessing a web data element, comprising:
a first browser and a second browser coupled to a first network, the first browser comprising:
a caching module configured to receive a copy of the web data element in response to a first request initiated from the first browser, and to store the copy of the web data element in a cache controlled by the first browser, wherein the copy of the web data element is stored as a cached web data element; and
a peer cache response module configured to receive a third request from the second browser wherein the third request is for the web data element and to provide a copy of the cached web data element to the second browser; and
the second browser comprising:
a peer cache request module configured to transmit a second request for the web data element to a home location of the web data element, to transmit the third request to an address accessible by the first browser, and to display the copy of the cached web data element.

19. A computer program product comprising a computer readable storage medium having computer program logic recorded thereon for causing a processor to enable a first browser to utilize cache maintained by a peer browser to access a web data element, said computer program logic comprising:
a first computer program that causes the processor to transmit a first request for the web data element to a home location of the web data element, and to transmit a second request for the web data element to an address accessible by the peer browser; and
a second computer program that causes the processor to display a copy of a cached web data element, wherein the cached web data element is a copy of the web data element residing in a cache controlled by the peer browser, wherein the copy of the cached web data element is received by the first browser before receiving a copy of the web data element.

20. A computer program product comprising a computer usable medium having computer program logic recorded thereon for causing a processor to enable a peer browser to maintain a cache usable to provide a web data element to a second browser, said computer program logic comprising:
a first computer program that causes the processor to receive a copy of the web data element in response to a first request initiated from the peer browser, and to store the copy of the web data element in a cache controlled by the peer browser, wherein the copy of the web data element is stored as a cached web data element; and
a second computer program that causes the processor to receive a third request from the first browser and to provide a copy of the cached web data element to the first browser, wherein the third request is sent in conjunction with a second request for the web data element sent to a home location of the web data element by the first browser.
